(19) United States
(12) Patent Application Publication
(10) Pub. No.: US 2018/0011530 A1
(43) Pub. Date: Jan. 11, 2018

(54) STANDBY POWER CONTROLLER WITH IMPROVED ACTIVITY DETECTION

(71) Applicant: EMBERTEC PTY LTD, Dulwich SA (AU)

(72) Inventor: Domenico Gelonese, Dulwich (AU)

(21) Appl. No.: 15/202,744

(22) Filed: Jul. 6, 2016

(51) Int. Cl. G06F 3/01; G09G 5/00; H04N 5/44

(52) U.S. Cl. CPC G06F 3/011; H04N 5/4403; G09G 5/006; H04N 2005/4432

(57) ABSTRACT

A standby power controller (SPC) supplies power to an appliance such as a television, and cuts power to the appliance if the appliance is going unused. The SPC includes first and second sensors, each detecting a type of user activity (such as user presence and remote control usage), and a switch which controls power to the appliance in dependence on the detection status of the first and second sensors, and also preferably in dependence on the prior detection status of at least one of the sensors at one or more points of time in the past.

### FIELD OF THE INVENTION

This invention relates to a standby power controller including multiple activity detection sensors.

### BACKGROUND OF THE INVENTION

The following references to and descriptions of prior products or other matter are not intended to be and are not to be construed as statements or admissions of common general knowledge in the art. In particular, the following prior art discussion does not relate to what is commonly or well known by the person skilled in the art, but may assist in the understanding of the inventiveness of the present invention, of which the identification of pertinent prior matter is but one part.

There is currently world-wide concern about the level of use of electrical energy for both domestic and commercial uses. In part this concern is based on the greenhouse gas production associated with the generation of electrical energy, and the contribution of that greenhouse gas to anthropogenic global warming. There is also a concern for the capital cost involved in building the electricity generating plants and electricity distribution networks required to generate and distribute an increasing amount of electricity.

A significant contributor to household energy use is household audio visual equipment, including devices such as televisions, television decoders, television recorders and sound equipment now found in virtually all homes.

### SUMMARY OF THE INVENTION

An exemplary version of the invention involves a standby power controller including a first sensor adapted to detect a first user activity; a second sensor adapted to detect a second user activity; and a switch adapted to control a supply of electricity to at least one appliance, wherein the state of the switch is dependent on the detection status of the first and second sensors.

Preferably, the first user activity is indicative of user active use of the appliance, and the second user activity is indicative of the presence of a user or potential user in the vicinity of the appliance, e.g., within the same room.

The state of the switch is preferably dependent on detection information which includes the current detection status of at least one sensor, and the prior detection status of at least one sensor at one or more points of time in the past.

The state of the switch is preferably further dependent on the detection status of at least one sensor at the time of the most recent past change in the switch state.

The standby power controller preferably further includes a power sensor adapted to sense the power drawn by the appliance(s), wherein the state of the switch is dependent on the output of the power sensor combined with the detection information.

The state of the switch is preferably further dependent on the time at which the detection status of the first sensor changes relative to the time at which the detection status of the second sensor changes.

The state of the switch is preferably further dependent on the detection status of at least one sensor at the time of the most recent past change in the switch state.

The first sensor preferably detects use of a remote control device which controls at least some functions of the appliance.

The second sensor preferably detects motion in the vicinity of the appliance.

The first sensor preferably detects use of an infra-red remote control which controls a television.

Preferably, the appliance is a television, and the first sensor detects use of a radio frequency remote control which controls one or both of the television and a set top box providing a video signal to the television.

The invention also involves a method of operation of a standby power controller, wherein inputs to a processor are the detection status of each sensor and past values of the detection status of at least one sensor, and the outputs of the processor determine the state of the switch and a value of a countdown timer.

The inputs to the processor preferably further include the value of a countdown timer.

### BRIEF DESCRIPTION OF THE DRAWINGS

The invention will now be described with reference to exemplary versions of the invention in connection with the accompanying drawings, in which:

FIG. 1 illustrates a standby power controller incorporating the invention.

FIG. 2 shows a flowchart of the operation of a version of the invention in a standby power controller (SPC) with a motion sensor.

FIG. 3 shows a flowchart of part of the operation of an SPC incorporating the invention, including two user activity sensors.

FIG. 4 shows a partial flowchart of the operation of the SPC of FIG. 1, including a version of the invention which incorporates a generalized Detection Analysis Module.

### DETAILED DESCRIPTION OF EXEMPLARY VERSIONS OF THE INVENTION

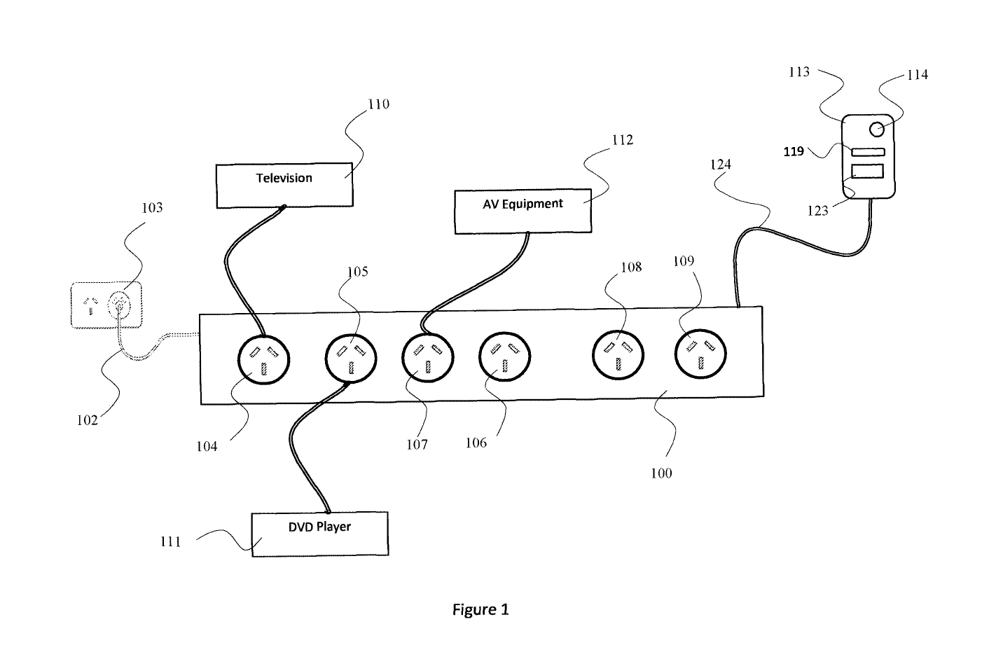

FIG. 1 is a general representation of an installation including a standby power controller (SPC) including the invention, and is illustrative only. It is not intended to limit the number or configuration of continually powered or switched or monitored main outlets, or of communication interfaces or other functional modules.

FIG. 1 schematically illustrates an energy saving device in the form of a standby power controller (SPC). An SPC is an energy saving device which is installed between the mains power supply and an electrical device. Electrical devices such as AV equipment are commonly “turned off” by being changed to a standby power state, which reduces, but does not eliminate, power consumption. Energy savings may be achieved by powering these types of devices by plugging them into an SPC. When the SPC detects that the equipment has entered a standby state, the SPC removes power from at least some of the equipment.

When a main device, for example a television, is in a standby state, it is desirable to remove power from the main device and any associated electrical devices. This is common where there is a subset of electrical devices such as televisions, video equipment, personal video recorders (digital video recorders), CD players, stereo systems, amplifiers, pay-television boxes, and other AV equipment grouped in close proximity and often used in combination with each other. The standby power controller (SPC) may also be equipped to remove power when all or a subset of the devices powered through it are in a standby state.

The standby power controller (SPC) 100 of FIG. 1 is adapted for use with AV equipment. The SPC 100 receives electrical power from a General Purpose Outlet 103 via power cord 102.

The standby power controller (SPC) 100 includes Monitored and Controlled Outlets 104, 105, 106, and 107. The SPC 100 also includes Uncontrolled Outlets 108 and 109. In general, any number of Monitored and Controlled Outlets and Uncontrolled Outlets may be provided. The Uncontrolled Outlets may be absent.

Monitored and Controlled Outlet 104 supplies electrical power to a television 110. Further Monitored and Controlled Outlets 105, 106 may provide electrical power to other audio-visual equipment, for example a DVD player 111 and audio equipment 112. If desired, multiple devices may be powered from any or each of the Monitored and Controlled Outlets using a powerstrip.

The standby power controller (SPC) 100 includes a Sensing and Communications Unit 113. In a preferred version of the invention, the Sensing and Communications Unit 113 is in data communication with the body of the SPC 100 via cable 124, which may also provide power to the Sensing and Communications Unit 113.

Modern television sets and other audio visual equipment, when turned “off” by a remote control, enter a low power “standby” state in which energy is still consumed, although at a significantly lower level that when the device is nominally “on”. When a television 110 is in this low power standby state it is not in use, and the power supply to it may be cut to save energy.

It is also the case that television sets may be left on for extended periods when no user is viewing the screen. This may happen when a user falls asleep in front of the television 110, or when a user, particularly a child or a teenager, simply leaves the vicinity of the television 110 without turning the television 110 off. This state may be termed “active standby”. In this state the television 110 is not in use, and the power supply to it may be cut to save energy.

The standby power controller (SPC) 100 may detect that the television 110 has entered a standby state of either kind by any convenient means, or combination of means.

In order to save energy, the standby power controller (SPC) 100 operates to remove the power supply from Monitored and Controlled Outlet 104, and hence from the attached television 110, whenever the television 110 is detected to not be in use, whether in a low power standby state or an active standby state. Power may also be removed from all other Controlled Outlets 105, 106, 107 since the devices powered through those outlets may only be in use only when the television 110 is in use. When power is removed from the Monitored and Controlled Outlets 104, 105, 106, 107 because the television 110 is in active standby, this action is termed Active Powerdown.

The standby power controller (SPC) 100 may include a power sensor adapted to sense the power drawn through a Monitored and Controlled Outlet 104, 105, 106, 107. The power sensor detects characteristics of the power flow through the outlet. When the characteristic is such as to indicate that the television 110 is in a standby state, the power to the Monitored and Controlled Outlet 104, and hence to the attached television 110 or monitor, is interrupted.

The standby power controller (SPC) 100 may include any number of Monitored and Controlled Outlets 104, 105, 106, 107, which may be monitored and controlled individually or together.

The standby power controller (SPC) 100 includes means to detect that a user is interacting with the audio visual equipment 112 and/or the television 110. The sensing and communications unit 113 includes a remote control use sensor 119, for example, an infra-red sensor. This sensor 119 receives infra-red signals from a remote control associated with the television 110 or with other connected AV equipment 112.

It is likely that a user, when actively watching television 110, will periodically use the remote control to change channels, adjust volume, mute commercials, etc. Thus, a remote control signal receiver, such as infra-red sensor 119, can be used as a remote control use sensor. If no remote control activity is detected by the infra-red sensor 119 for a period of time, it can be assumed that the television 110 is not in use, and the power supply to the Monitored and Controlled Outlet 104, and hence to the television 110, may be interrupted. This may be achieved by using a countdown timer which starts from a specific initial value equal to a particular time period, say one hour, and having this countdown timer continuously decrement. Each detected use of the remote control will reset the countdown timer to the initial value. When the countdown time reaches zero, there has been no remote control activity for the time period, and the television 110 is therefore assumed not to be in active use, that is, to be in an active standby state. Thus, the electricity supply to the Monitored and Controlled Outlet 104, and hence to the television 110, is interrupted. In a preferred version of the invention, the supply of electricity to all Monitored and Controlled Outlets 104, 105, 106, 107 is interrupted at the same time.

The determination that the television 110 is in an active standby state may be modified by determining that a user is present in the vicinity of the television 110. Any suitable user presence sensor may be used for determining that a user is present. These include, without limitation, passive infra-red sensors, ultrasonic sensors, cameras, any other passive or active movement sensors, and sound detectors. Such sensors may also be called occupancy sensors.

The standby power controller (SPC) 100 of FIG. 1 includes motion sensor 123. The detection status of the motion sensor 123, that is, whether it is detecting motion 204, is combined with the detection status of the remote control use sensor 119 to allow a better determination of active standby status, as described further below.

Whatever means is used to determine that the television 110 is on, but not in use, it is unlikely to be completely free of false positives, that is, determining that the television 110 is in active standby and not in use when the television 110 is in fact in use. If the television 110 is turned off when a user is still watching a program, the user will be irritated. Repeated occurrences are likely to lead to the user bypassing the power control function of the standby power controller (SPC) 100, thereby preventing power savings and thwarting the SPC's objectives.

The Sensing and Communications Unit 113 includes a warning indicator 114, e.g., a warning LED. When the standby power controller (SPC) 100 determines that the television 110 is in active standby, the warning LED 114 will flash to alert any user to the imminent shutdown of the power to the television 110. This time between the determination that the television 110 is in active standby, and the shutdown of the television 110, is the Shutdown Warning Period. In a preferred version of the invention this is ten minutes, but any other suitable time period may be chosen. In the case where there is a false positive, that is, there is a user watching the television 110, the user may react to observing the flashing of the warning LED 114 by pressing a key on the remote control and/or by moving. The signal from the remote control is detected by the remote control use sensor 119, and/or the movement is detected by motion sensor 123. In reaction to such detection, the SPC 100 causes the countdown timer to be reset, preventing interruption of power to the television 110.

In lieu of the warning LED 114, other methods for warning of imminent shutdown of power to the television 110, such as an audible warning tone, may be used.

The standby power controller (SPC) 100 may include software allowing control of the warning mechanism. For example, the brightness of the LED 114, and/or the Shutdown Warning Period, may be adjustable. It may be possible to set times when the warning should take certain forms. For example, an audible warning may be used at certain times of the day, while the LED 114 is used at other times, or both may be used together at given times. At still further times, no warning at all may be given.

Uncontrolled Outlets 108 and 109 are optionally provided to allow power to be supplied to devices which should not have the power supply cut when the television 110 is not in use. Each Uncontrolled Outlet 108/109 supplies power at all times when the standby power controller (SPC) 100 is plugged in. Any number of Uncontrolled Outlets may be provided.

Devices other than a television 110 may be connected to the Monitored and Controlled Outlets 104, 105, 106, 107 along with a television 110. In this case, the total load of all devices may be monitored for the characteristics indicating that all devices so connected are in a standby or unused state.

One or more of a third type of power outlet (not shown) may be provided. This non-monitored, controlled outlet is not monitored by the power sensor, so the power drawn by any load connected to the outlet does not contribute to the determination that the monitored load is in a standby or unused state. This outlet is controlled, such that when power is interrupted to the Monitored and Controlled Outlets 104, 105, 106, and 107, power is also interrupted to this outlet.

A fourth (and optional) type of outlet (not illustrated) is monitored, but not controlled. The power drawn through this outlet contributes to the determination that the monitored load is in a standby or unused state. However, the standby power controller (SPC) 100 does not interrupt power to this outlet. This is similar to the “master” outlet in a standard “master/slave” SPC, known in the art as a Tier 1 SPC.

When the standby power controller (SPC) 100 removes power from the Monitored and Controlled Outlets 104, 105, 106, and 107, power is removed from the television 110. The television 110 is in a completely unpowered state, rather than the low power standby state which the television 110 would enter if switched off using the remote control. This means that the television 110 is unable to monitor for use of the remote control in order to be turned on. While power is cut off from the television 110 by the standby power controller (SPC) 100, use of the remote control will be detected by the SPC 100. Typically, a user will seek to turn on the television 110 using the remote control. This will be detected by the SPC 100, and a switch within the SPC 100 will be activated to return power to the television 110. The television 110 will receive power, and may then enter a low power standby state. Further use of the remote control may then be required to turn the television 110 to a fully active state.

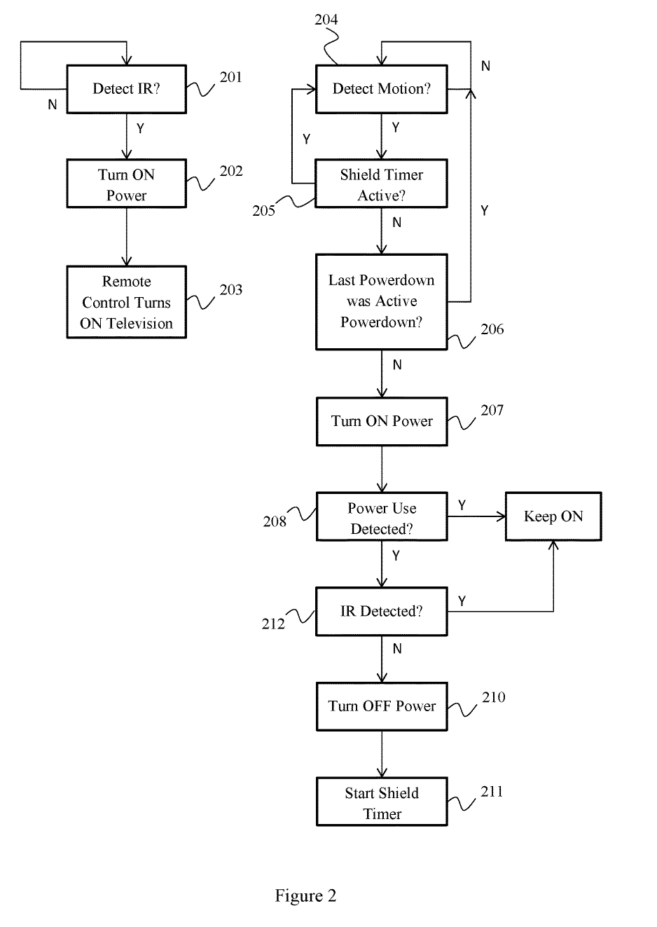

FIG. 2 shows a flowchart of the operation of a version of the invention in a standby power controller (SPC) 100 with a motion sensor 123 as in FIG. 1, where the second use of the remote control may not be required. A user presence/occupancy sensor operates to cause the SPC 100 to restore power to the appliance when a user is present in the vicinity of the appliance, when it is likely that the presence of the user indicates that the appliance is to be used.

At 201, a remote control use detector, in this version an infra-red detector, continuously senses for a signal indicating user usage of a remote control associated with equipment powered through the standby power controller (SPC). While the detection status of the remote control use detector indicates that infra-red is not detected, the process loops, continuing to sense for infra-red detection. When infra-red is detected, the SPC acts (at 202) to turn on the power to the controlled outlets of the SPC, and hence to an appliance or appliances which are controlled by the remote control. In the illustrated version of the invention, the appliance is a television.

At 203, a user uses the remote control to turn on the television, which is supplied with power by the standby power controller (SPC).

A user presence/occupancy sensor operates in parallel with the remote control use detector, sensing for the presence of a user in the vicinity of the appliance (at 204). In the illustrated version of the invention, the occupancy sensor is a motion detector. The motion detector continuously senses motion, looping while no motion is detected.

When the motion sensor detects motion, there is a check Shield Timer Active? (at 205). The Shield Timer is a timer which is set to reduce the motion detection which is not associated with television use, as described further herein. The Shield Timer causes motion sensing to be ignored for a period of time after sensing motion which was not associated with use of the appliance. Where the Shield Timer is active, no action occurs, and the standby power controller (SPC) continues to monitor for motion at 204.

Where the Shield Timer is not active, a check Last Powerdown was Active Powerdown? is made at 206. When the standby power controller (SPC) removes the power from the controlled outlets because the television is in active standby, this action is termed Active Powerdown. In this case it is probable that returning power to the television will immediately result in the television turning on, that is, entering a fully active state without requiring any use of the remote control. This may be undesirable in the case where the occupancy detected by the motion detector is not associated with a desire by a user to use the television.

Where the check 206 Last Powerdown was Active Powerdown? yields a true result, that is, on the last occasion that the standby power controller (SPC) removed power from the television this was due to a determination that the television was in active standby, then no action is taken. The SPC continues to detect motion 204 and to detect infra-red 201. This prevents the television coming on due to detection of movement without any indication from a user of a desire to use the television.

Where the last withdrawal of power was not Active Powerdown, this indicates that the previous withdrawal of power was prompted by the television being detected to be in a low power standby state. Generally this means that when power is restored to the television, it will not immediately enter a fully on state.

The standby power controller (SPC) switch is operated (at 207) to supply power to the television. The television enters a low power standby mode in which the television is operable by the remote control. Should the user wish to use the television, the user operates the television remote control, causing the television to enter a fully on mode.

In a version of the invention where the standby power controller (SPC) is provided with a power sensor, the power sensor detects (at 208) the increased power use caused by the television entering the fully active mode. The SPC takes no action and power continues to be supplied to the television, which will remain on.

The standby power controller (SPC) may, instead of or in addition to monitoring the power drawn by the television, monitor the infra-red signal from the remote control. Where the infra-red signal is detected (at 212), the SPC will take no action and power will continue to be supplied to the television, which will remain on.

Where neither power use nor infra-red use are detected, the standby power controller (SPC) will operate the switch 210 to remove power from the controlled outlets.

If the detected movement was not indicative of a desire by the user to use the television, the user may remain in the vicinity of the television without using it. Accordingly, motion may be ignored for a period of time to avoid wasting energy by switching the television into the low power standby mode unnecessarily. The standby power controller (SPC) starts a Shield Timer (at 211). The Shield Timer remains active for a selected time. While the Shield Timer remains active, the SPC, at step 205, will not react to detected movement. In a preferred version, the Shield Timer selected time is two hours, though any suitable time period may be chosen (and may be user selected).

A standby power controller (SPC) may have only a single user activity sensor. This may be a motion sensor 123 configured to detect the presence of a user, or a remote control use sensor configured to detect a user using a remote control to control a television or another device. The function of the user activity sensor(s) is to provide data for the identification of the active standby state of the television, that is, when the television is fully powered but is not actually being used or watched. SPCs are subject to two types of error. A false positive occurs when the SPC fails to identify that a user is present and actively using or seeking to use a controlled appliance such as a television, and thus incorrectly determines that the television is in an active standby state. The SPC then turns off the television when the television is in fact in use, or fails to return power to the television when a user wishes to use the television. A false negative occurs when the SPC incorrectly determines that a user of the television is present, and allows the television to remain powered when the television is not in use, or returns power to the television when no user is intending to use the television.

The addition of different types of user activity sensors, acting independently in parallel, decreases the likelihood of false positive errors. The more types of user activity that are sensed, the more likely it is that user activity associated with use of the television will be detected. However, the addition of different types of user activity sensors, acting independently in parallel, will increase the likelihood of false negative errors. The more activities of a user that are sensed, the more likely it is that a sensed activity will not in fact be related to a user's use of, or desire to use, an appliance such as a television.

False positive errors lead to user frustration and dissatisfaction with the standby power controller (SPC). This leads to the SPC being de-installed, which prevents the SPC from achieving any energy savings. False negative errors are less likely to be noticed by a user, but such errors result in reduced energy savings since the appliance remains on, or is switched on, when it is not required.

Using more than one sensor type in parallel, but considering the output of each sensor in light of information provided by one or more other types of sensors, allows at least some of the benefits of reducing false negative errors, without unacceptably increasing the degree of false positive errors.

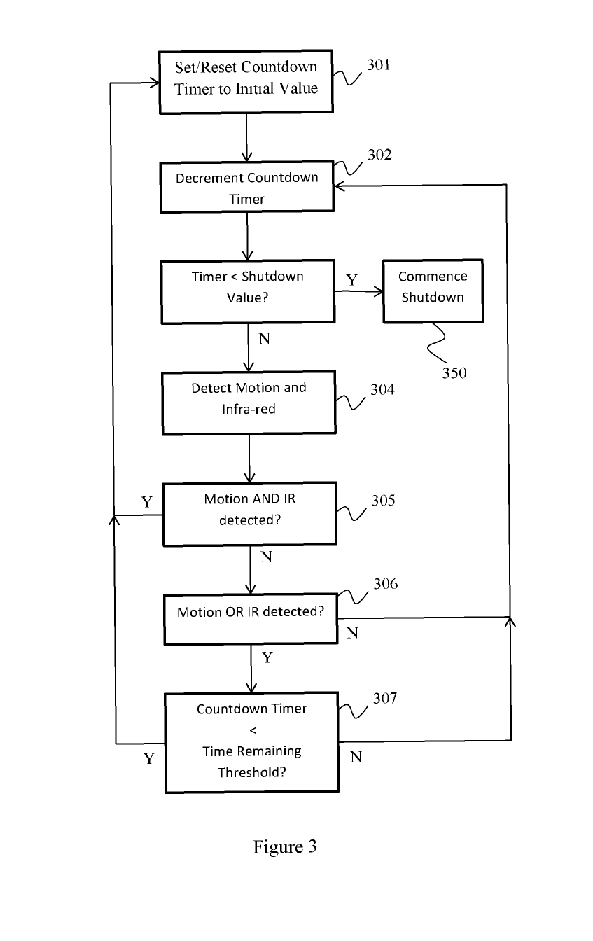

FIG. 3 shows a flowchart of part of the operation of a standby power controller (SPC) of a type similar to that illustrated in FIG. 1, including two user activity sensors. The first sensor is a usage sensor which detects use of an appliance by a user, such as an infra-red sensor capable of detecting use of an infra-red remote control for a television. The second user activity sensor is a user presence/occupancy sensor capable of detecting the presence of a user in the vicinity of an appliance, such as a motion sensor able to detect movement of a user in the vicinity of a television.

Referring to step 301 of FIG. 3, a countdown timer is set to an initial value. This countdown timer value is the period of time which will elapse before the standby power controller (SPC) removes power from the Monitored and Controlled Outlets if no relevant user activity is detected. The initial value may be set when the SPC is manufactured, or it may be able to be field-set by a user, or algorithmically set by the SPC over a period of use.

In the process illustrated in FIG. 3, the initial value is a starting value, and the countdown timer counts down to zero. Other arrangements are possible, e.g., the initial value could be a terminal value, where the count timer starts at zero and counts up to the terminal value.

At 302, the countdown timer is decremented. At 303, there is a check that the value of the countdown timer remains above a value which would cause the shutdown procedure to commence (at 350). The value of the countdown timer which causes shutdown is preferably zero, but other values are possible. If the countdown timer is below this value, the shutdown procedure 350 is entered.

The shutdown procedure 350 may involve immediate removal of power from the controlled outlets, or it may be the beginning of a warning cycle which culminates in the withdrawal of power from the controlled outlets should a relevant user activity not be detected.

While the countdown timer value remains above the shutdown threshold, both user activity sensors operate (at 304) to detect user operation of a remote control and user motion in the vicinity of the television.

At 305, a check is made for simultaneous or near-simultaneous detection by both sensors (e.g., detection within 0-2 seconds of each other). If this occurs, the countdown timer is set at step 301 to the initial value, and execution continues from step 301.

Where both detectors have not at least substantially simultaneously detected user activity, a check is made at 306 for detection by either activity sensor. Where no user activity detection has occurred, the countdown timer is decremented at 302 and execution continues therefrom.

Where one of the user activities has been detected, a check is made at 307 as to how close the countdown timer is to reaching the shutdown threshold. For this check a Time Remaining Threshold is defined, this being a period of time whereby the removal of power from the controlled outlets and consequent turning off of the television is imminent. Preferably the Time Remaining Threshold is ten minutes. The Time Remaining Threshold may be factory set, or may be field-settable by a user or installer.

Where the countdown timer value remains above the Time Remaining Threshold, the check 307 is followed by decrementing the countdown timer at 302, with execution continuing therefrom. Where the countdown timer value is less than the Time Remaining Threshold, the check 307 is followed at step 301 by a reset of the countdown timer, with execution continuing from step 301.

In an exemplary version of the invention, the Time Remaining Threshold may be the same as the Shutdown Warning Period. This addresses the case where a user may have been watching the television without moving and without using the remote control, for example when watching a long program. The lack of movement and lack of remote control use cause the standby power controller (SPC) to incorrectly determine that the television is in an active standby state, and to commence power shutdown by activating the warning mechanism. When the warning LED or other warning device is activated, the user wishes to quickly indicate their presence and continued interest in using the television. In this case, it is not necessary to find the remote control, and simply moving—for example, waving a hand—will be sufficient to abort the shutdown.

As another option, the Time Remaining Threshold may be different depending upon which sensor has a detection status indicating that detection of the relevant user activity has been made.

The Time Remaining Threshold may be set to zero, which will require that both movement and infra-red detection must occur in order for user presence to be determined, and in order to avoid the determination that the television is in active standby. This may be useful in environments where movement not associated with use of the television, and spurious infra-red (e.g., from CFL lighting and unrelated remote control devices), are prevalent.

As another option, the detection by one activity sensor may be weighted more heavily than detection by the other activity sensor.

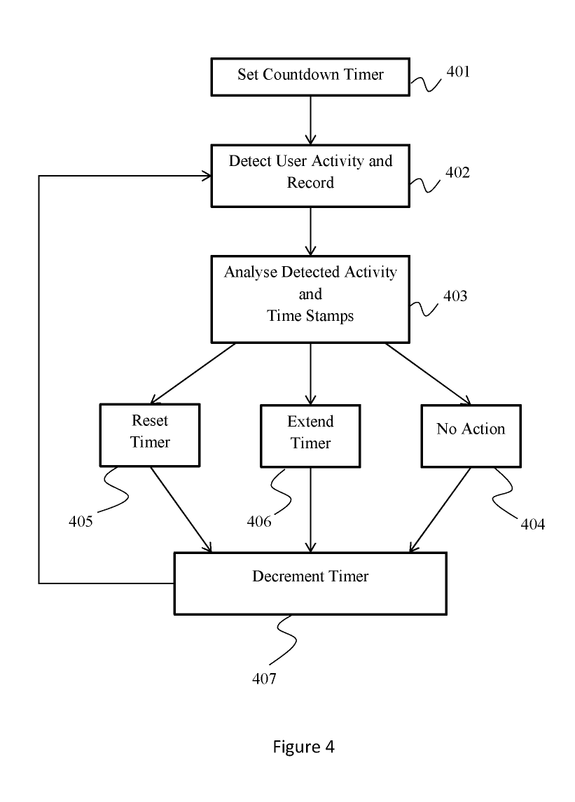

FIG. 4 shows a partial flowchart of the operation of an standby power controller (SPC) employing the hardware implementation of FIG. 1, which incorporates a generalized Detection Analysis Module which allows the SPC to vary the response to activity detection based on at least two of: the current detection status of any sensor, the past detection status of any sensor, and the value of the countdown timer.

At step 401, the countdown timer is set to a selected initial value. This value may be factory set, or it may be field settable by a user or installer.

At least two user activity sensors are provided, preferably a sensor for detecting remote control use (e.g., an infra-red detector) and an occupancy sensor for detecting the presence of a user in the vicinity of a television (e.g., a motion detector).

At step 402, the detection status of the activity sensors is checked and recorded. The detection status of each of the sensors is recorded in electronic memory along with a time stamp. The time stamp may be the value of the countdown timer at the time that the detection status is recorded. It may be the absolute time, in any convenient standard or format, or an arbitrary time value based on a count from some previous event. The time stamp need merely allow for the relative positioning in time of the sensor readings.

At step 403, the detected activity is analyzed by a generalized Detection Analysis Module along with the time stamps. The outcome of this analysis may be one of three actions, depending on the likelihood that the detected status and timer values indicate the presence of a television user. At 405, where the analysis indicates a high likelihood that there is a user present, the standby power controller (SPC) may reset the countdown time to the initial value. At 406, where the analysis indicates there is a lesser likelihood that a user is present, the SPC may extend the countdown timer value to a time period greater than the current value, but less than the initial value. At 404, where the analysis indicates little likelihood of the presence of a user, the SPC may do nothing, allowing the countdown timer value to remain unchanged. The analysis may also take into account the likelihood of the selected action leading to a false positive result where the television is turned off when it is in fact in use. In each case, the countdown timer is then decremented at 407, and execution continues from step 402 with detection of status of the activity sensors and recording of that status.

The Detection Analysis Module steps employed at step 403 will consider at least two of the detection status of a sensor, the detection status of a sensor at some time in the past, and the absolute value of the countdown timer. These may be analyzed in any desired variations. For example, if (1) motion is detected; (2) motion has been previously detected in the preceding five minutes; and (3) the countdown timer is within 5% of the initial value, the chosen action may be to do nothing at 404. This action is chosen because even though the multiple movement detections indicate a reasonable likelihood of a user being present, the chance of a false positive determination is not high, because such a determination cannot be made until the countdown timer is exhausted. In contrast, if (1) motion is detected; (2) motion has been previously detected in the preceding five minutes; and (3) the countdown timer is within 5% of the terminal value, the chosen action may be to extend the timer at 406 to 40% of the initial value. This is because the multiple movement detections indicate a reasonable likelihood of a user being present, and the chance of a false positive determination is moderate, because there is little time left until the countdown timer is exhausted.

As another example, if (1) remote control use is detected; (2) no motion is detected; and (3) the countdown timer is within 10% of the initial value, the chosen action may be to do nothing at 404, because detection of infra-red without movement is possibly spurious, and the risk of a false positive determination is still low. In contrast, if the conditions are (1) remote control use is detected; (2) no motion is detected; and (3) the countdown timer is within 10% of the terminal value, the chosen action may be to extend the timer at 406 to 60% of the initial value, because although detection of infra-red without movement is possibly spurious, the risk of a false positive determination is now high since the countdown timer is close to exhaustion.

As another example, if (1) motion is detected; (2) remote control use is detected; and (3) the countdown timer may have any value, the chosen action may be to reset the countdown timer at 405 to the initial value, since there is a high probability that a user is present.

The Detection Analysis Module may be programmed with a full or partial matrix of input vs. output results, with inputs being the detection status of each sensor, the past detection status of each sensor, and the value of the countdown timer, and outputs being the switch status to be set and the value of the countdown timer to be set. The choice of results for each combination is made in such a way as to balance the risks of false positive and false negative results. The nature of this balance will vary depending upon the relative undesirability of each possible false result. That is, the risk of annoying users is balanced against the risk of reduced power savings.

The invention is not limited to the exemplary versions of the invention described above, but rather is intended to be limited only by the claims set out below. Thus, the invention encompasses all different versions that fall literally or equivalently within the scope of these claims.

What is claimed is:

1. A standby power controller including:
a. a first sensor providing a first sensor status dependent on detection of a first user activity;
b. a second sensor providing a second sensor status dependent on detection of a first user activity;
c. a switch having:
(1) an on state wherein electricity is supplied to an appliance through the switch, and
(2) an off state wherein no electricity is supplied to the appliance through the switch;
wherein the state of the switch is dependent on both the first sensor status and the second sensor status.

2. The standby power controller of claim 1 wherein:
a. the first user activity is indicative of user usage of the appliance, and
b. the second user activity is indicative of the presence of a user in the vicinity of the appliance.

3. The standby power controller of claim 2 wherein the second sensor detects motion in the vicinity of the appliance.

4. The standby power controller of claim 2 wherein the first sensor detects use of a remote control device which controls the appliance.

5. The standby controller of claim 4 wherein the first sensor detects use of an infra-red remote control which controls a television.

6. The standby controller of claim 4 wherein:
a. the appliance is a television, and
b. the first sensor detects use of a radio frequency remote control which controls at least one of:
(1) the television, and
(2) a set top box providing a video signal to the television.

7. The standby power controller of claim 1 wherein the state of the switch is dependent on:
a. the current sensor status of at least one of the sensors, and
b. the sensor status of at least one of the sensors during at least one past moment of time.

8. The standby power controller of claim 7 wherein the state of the switch is further dependent on the sensor status of at least one of the sensors at the time of the most recent past change in the state of the switch.

9. The standby power controller of claim 7 further including a power sensor adapted to sense the power drawn by the at least one appliance, wherein the state of the switch is dependent on the output of the power sensor combined with the detection information.

10. The standby power controller of claim 1 wherein the state of the switch is further dependent on the time at which the detection status of the first sensor changes relative to the time at which the detection status of the second sensor changes.

11. The standby power controller of claim 10 wherein the state of the switch is further dependent on the detection status of at least one sensor at the time of the most recent past change in the switch state.

12. The standby power controller of claim 1 further including:
a. a timer configured to count time; and
b. a processor defining:
(1) the state of the switch, and
(2) the count of the timer,
in response to:
i. the current sensor status of each of the sensors, and
ii. the sensor status of at least one of the sensors during at least one past moment of time.

13. The standby power controller of claim 12 wherein the switch is placed in the off state when the timer attains a predetermined time count.

14. The standby power controller of claim 1:
a. wherein:
(1) the first sensor detects use of a remote control device which controls the appliance, and
(2) the second sensor detects motion in the vicinity of the appliance,
b. further including a timer configured to:
(1) count in time,
(2) trigger the off state of the switch if neither remote control device use nor motion in the vicinity of the appliance are detected during the time leading up to a predetermined time count, and
(3) restart the timer's counting in time if both remote control device use and motion in the vicinity of the appliance are detected at least substantially simultaneously.

15. The standby power controller of claim 14 wherein the timer is further configured to restart the timer's counting in time if:
a. the timer has counted time which approaches the predetermined time count to within a predefined remaining time interval, wherein the predefined remaining time interval is less than the predetermined time count, and
b. motion in the vicinity of the appliance is detected within the predefined remaining time interval.

16. The standby power controller of claim 15 wherein the timer is further configured to restart the timer's counting in time if remote control device use is detected within the predefined remaining time interval.

17. The standby power controller of claim 1:
a. wherein:
(1) the first sensor detects use of a remote control device which controls the appliance, and
(2) the second sensor detects motion in the vicinity of the appliance,
b. further including a timer configured to:
(1) count in time,
(2) trigger the off state of the switch if neither remote control device use nor motion in the vicinity of the appliance are detected during the time leading up to a predetermined time count, and
(3) restart the timer's counting in time if:
(a) the timer has counted time which approaches the predetermined time count to within a predefined remaining time interval, wherein the predefined remaining time interval is less than the predetermined time count, and
(b) either of remote control device use and motion in the vicinity of the appliance are detected during the predefined remaining time interval.

18. The standby power controller of claim 1:
a. wherein:
(1) the first sensor detects use of a remote control device which controls the appliance, and
(2) the second sensor detects motion in the vicinity of the appliance,
b. further including a timer configured to:
(1) count in time toward a predetermined time count,
(2) trigger the off state of the switch if neither remote control device use nor motion in the vicinity of the appliance are detected during the time leading up to a predetermined time count, and
(3) increase the predetermined time count if:
(a) the timer has counted time which approaches the predetermined time count to within a predefined remaining time interval, wherein the predefined remaining time interval is less than the predetermined time count, and
(b) motion is detected in the vicinity of the appliance:
i. during the predefined remaining time interval, and
ii. within five or fewer minutes after a prior separate motion was detected in the vicinity of the appliance.

19. The standby power controller of claim 1:
a. wherein:
(1) the first sensor detects use of a remote control device which controls the appliance, and
(2) the second sensor detects motion in the vicinity of the appliance,
b. further including a timer configured to:
(1) count in time toward a predetermined time count,
(2) trigger the off state of the switch if neither remote control device use nor motion in the vicinity of the appliance are detected during the time leading up to a predetermined time count, and
(3) increase the predetermined time count if:
(a) the timer has counted time which approaches the predetermined time count to within a predefined remaining time interval, wherein the predefined remaining time interval is less than the predetermined time count, and
(b) remote control device use is detected, without detection of motion in the vicinity of the appliance, during the predefined remaining time interval.
